(19) United States
(12) Patent Application Publication
(10) Pub. No.: US 2008/0261085 A1
(43) Pub. Date: Oct. 23, 2008

(54) Biological Battery or Fuel Cell Utilizing Mitochondria

(75) Inventors: Ann M. Sastry, Ann Arbor, MI (US); Muinsh V. Inamdar, Ann Arbor, MI (US); Chia W. Wang, Ann Arbor, MI (US); Martin Philbert, Northville, MI (US); James A. Miller, Whitmore Lake, MI (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: THE REGENTS OF THE UNIVERSITY OF MICHIGAN, Ann Arbor, MI (US)

(21) Appl. No.: 12/059,212

(22) Filed: Mar. 31, 2008

Related U.S. Application Data
(60) Provisional application No. 60/909,369, filed on Mar. 30, 2007.

(51) Int. Cl. H01M 8/16; H01M 4/60

(52) U.S. Cl. 429/2; 429/212

(57) ABSTRACT

A battery or fuel cell that includes at least one electrode having a biological component. The biological component may be formed on the cathode and may consist of a material including mitochondria.

### CROSS-REFERENCE TO RELATED APPLICATIONS

This application claims priority to and benefit from U.S. Provisional Patent Application Ser. No. 60/909,369, filed Mar. 30, 2007, entitled Bio-Hybrid Power Source, the disclosure of which is hereby incorporated herein by reference for all purposes.

### GOVERNMENT FUNDING

The U.S. Government may have certain rights in this invention as provided for by the terms of Grant No. FA9550-06-1-0098, “Quantitative Prediction of Available Power in Mitochondrial Arrays for Compact Power Supplies,” awarded by Air Force Office of Scientific Research.

### TECHNICAL FIELD

This patent relates to an electrochemical power source, i.e., a biological battery that incorporates an organic/biological electrode composition.

### BACKGROUND

Mitochondria are the power plants of most eukaryotic cells because of their ability to generate energy used by the cell. The biology of mitochondria is well known and understood. Mitochondria feature an outer membrane, a highly folded inner membrane, an intermembrane space and a matrix space enclosed by the inner membrane. Techniques for harvesting mitochondria furthermore, are understood and defined. Importantly, mitochondria can provide a source of hydrogen ion or electrons that may participate in oxidation/reduction reaction with other materials to provide an electron flow.

While mitochondria offer a potential near limitless source of power, their actual capacity to produce power, and in particular direct current electricity, is not well known or understood.

### SUMMARY OF THE INVENTION

Embodiments of the invention provide for the generation of power from mitochondria. Mitochondria are the power plants of eukaryotic cells. Embodiments of the invention are for the harnessing of these power plants without isolating the sub-cellular enzymes that participate in power generation. Mitochondria may be used in a cathode as well as in an anode. In one embodiment, the ability of mitochondria to pump protons in the intermembrane space is used to incorporate mitochondria in a cathode with a metallic anode in an electrochemical cell. The metallic anode is the electron donor while mitochondria act as the cathodic active material, generating protons.

In an alternate embodiment, a fuel cell is constructed where electrons are shuttled from mitochondria using an artificial electron acceptor, The electron sink is a ferricyanide solution, or other reducing substance that accepts electrons.

In the various embodiments, pyruvate or succinate or other derivatives of pyruvate may be used as the mitochondrial fuel. Gold, carbon, polymeric or other inert, electronically conductive electrode substrates are used to collect electrons from mitochondria.

Embodiments of the invention may be found ideal for implantable, renewable power sources because mitochondria are already present in eukaryotic cells, and the larger biological systems that they populate. Harnessing electric energy from mitochondria could save considerable costs associated with isolation and implantation of enzymes.

### BRIEF DESCRIPTION OF THE DRAWINGS

FIG. 1 is a schematic illustration of a battery that may incorporate one or more electrodes having a biological component in accordance with the herein described embodiments.

FIG. 2 is a schematic representation of a battery incorporating one or more electrodes having a biological component in accordance with alternate described embodiments.

FIG. 3 is a section taken through the cathode of the battery illustrated in FIG. 2 along line 3-3.

FIG. 4 is schematic representation of a battery incorporating one or more electrodes having a biological component in accordance with alternate described embodiments.

FIG. 5 is a plan view of a plate of the battery shown in FIG. 4.

FIG. 6 is a plan view of an alternate plate of the battery shown in FIG. 4.

FIG. 7 is a schematic illustration of a battery incorporating one more or more electrodes having a biological element in accordance with the fuel cell scheme.

FIG. 8 is a plan view of the end plate of the battery shown in FIG. 7.

### DETAILED DESCRIPTION

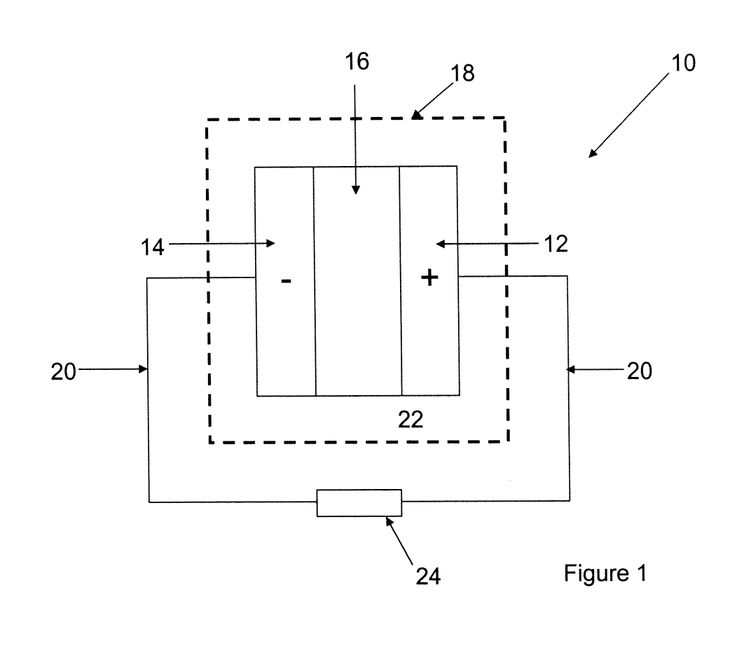

A bio-hybrid cell incorporates an organic/biological electrode composition for at least one of the anode or cathode. As depicted in FIG. 1, a power cell 10 includes a cathode 12, an anode 14 separated by a separator 16 within a container 18. The container is filled with electrolyte 22. The cell 10 produces direct current that is coupled to a load 24 via leads 20. One or both of the cathode 12 and the anode 14 include(s) a biological component. For example, the cathode 12 or the anode 14 may include a layer or formation of mitochondria on a substrate such as glass, metal plated glass or metal.

Methods of harvesting of mitochondria are well known and understood, and a full discussion of methods or techniques is not given here. A brief summary of a suitable methodology includes collection of liver tissue from a Fischer 344 rat or other suitable donor and storage of the tissue in an extraction buffer. The harvested tissue is homogenized and multiple-stage centrifuged. The centrifuging yields a mitochondria pellet that may be resuspended to release individualized mitochondria.

Table I list several well characterized battery cell chemistries and the associated oxidation/reduction equation yielding a net electron flow. Included in Table I is a cell chemistry in accordance with the embodiments of the invention including a biological (mitochondrial) cathode and a zinc anode.

TABLE I
Battery Cell Chemistries

| chemistry | material | | polarity | process | reaction | equation |
|---|---|---|---|---|---|---|
| Li-ion | anode | Li_{1-y}C₆LiC₆ | +− | CHADCH | REDOX | 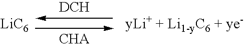 |
| | cathode | Li_{1-x+y}MO₂Li₁₋ₓMO₂ | −+ | CHADCH | OXRED | 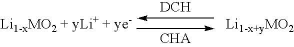 |
| NiMH | anode | MMH | +− | CHADCH | REDOX | 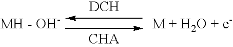 |
| | cathode | Ni(OH)₂NiOOH | −+ | CHADCH | OXRED | 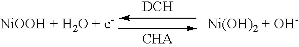 |
| Zn/Au | anode | Zn | − | DCH | OX | Zn + 2H₂O → Zn(OH)₂ + 2H⁺ + 2e⁻ |
| | cathode | Au/H⁺ | + | DCH | RED | 2H⁺ + 2e⁻ → H₂ |
| Zn/Mito | anode | Zn | − | DCH | OX | Zn + 2H₂O → Zn(OH)₂ + 2H⁺ + 2e⁻ |
| | cathode | Au/H⁺ | + | DCH | RED | 2H⁺ + 2e⁻ → H₂ |

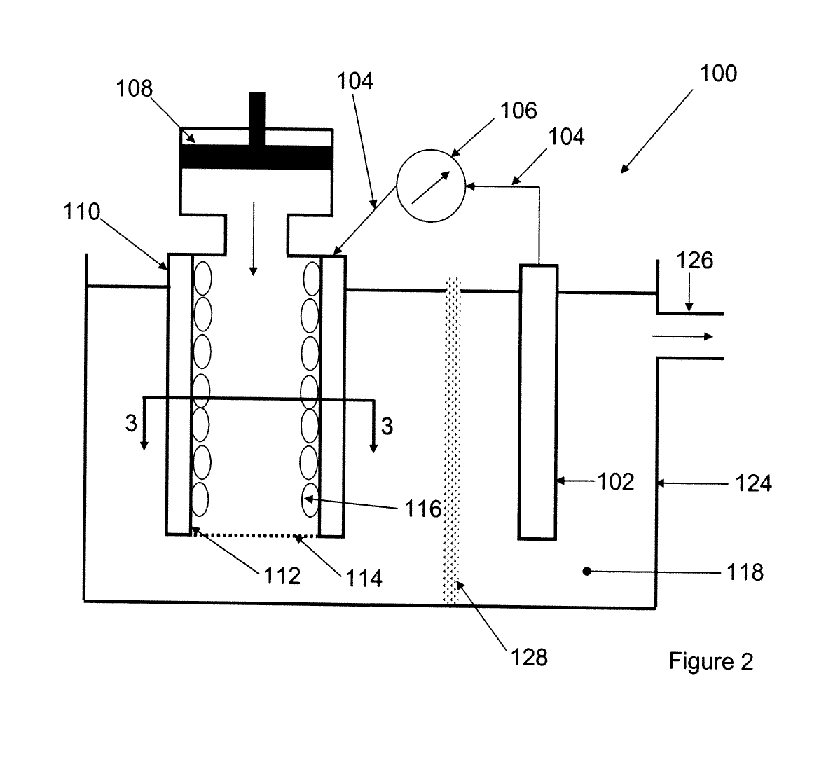

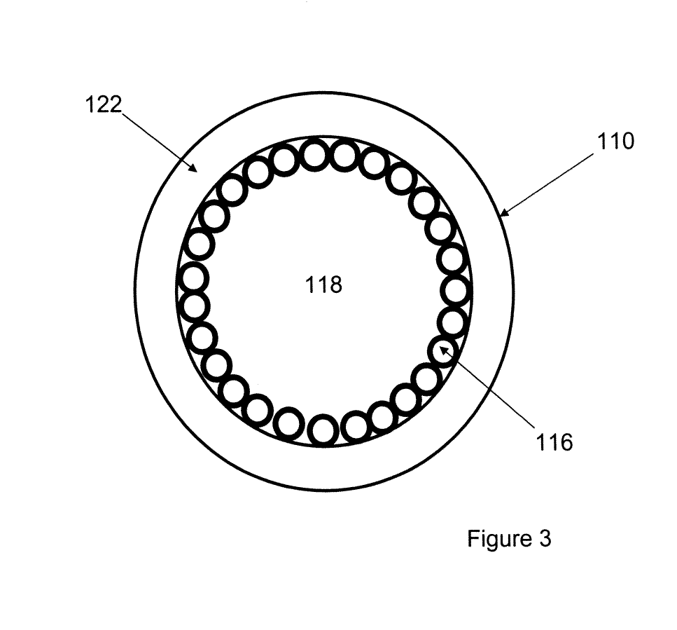

Referring now to FIGS. 2 and 3 a battery cell 100 is depicted. The cell 100 includes a container 124, a cathode assembly 110 and anode assembly 102 coupled by leads 104 to a load 106. The container 124 may be flooded with electrolyte 118. Electrolyte 118 may be caused to flow through the container 124 by a pump 108. As depicted, the pump may be a reciprocating piston type device. In experimentation, a syringe may substitute for the pump 108. Excess electrolyte 118 may flow from the container 124 via a drain 126. The electrolyte may be recirculated. A separator 128 is disposed in the container 124 between the cathode assembly 110 and the anode assembly 102.

The cathode assembly 110 may include an annular cylinder 122. The cylinder 122 may be formed from glass or other suitable non-conductive substrate material, a metal plated glass or a metal or metal alloy. A biological component 116 is disposed upon an inner surface 112 of the cylinder 122. A screen 114 may be disposed at a bottom portion (as depicted in the drawing) of the cylinder 122 to prevent transport of the biological component with flow of the electrolyte 118. The cathode assembly 110 may be formed from a solid cylinder, a rod, a plate or other suitable structure. The anode assembly 102 may be a bar, flat plate or strip of metal. The separator may be a polymer film material, and, for example, a sheet of Celgard® or other polyethylene or polyolefin membranes having nanoscale pores.

The cathode assembly 110 is disposed in a first compartment of the container 124 and the anode assembly 102 is disposed in a second compartment. The cathode assembly 110 and anode assembly 102 are joined by the leads 104 that may include meter 106 for indicating a cell voltage, current flow or both, or the leads may couple to a load.

As noted, the inner surface 112 of the cylindrical cathode assembly 110 includes a layer 116 of an organic/biological composition. In various embodiments of the invention, the composition 116 is composed of mitochondria. The Table II, below, lists suitable materials for the cathode/mitochondrial substrate 110, the organic/biological layer 116, anode assembly 102, electrolyte 118, separator 128 and container 124. Also indicated in Table II are additional considerations in association with materials selection.

TABLE II
Exemplary Cell Materials

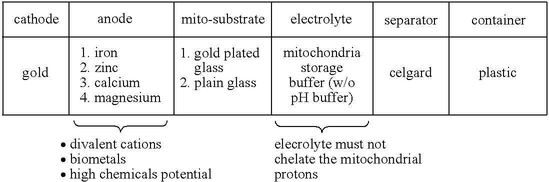

As described in Table II, the electrolyte may be a mitochondrial storage buffer without a pH buffer. A suitable mixture may include 250 mM sucrose, 0.08 mM andenosine diphosphate (ADP); 5 mM succinate acid (sodium succinate) and 2 mM dipotassium phosphate (K₂HPO₄). A buffer with a weak pH buffer may include 220 mM mannitol, 70 mM sucrose, 0.5 mM ethylene glycol tetraacidic acid (EGTA), 2 mM 4 -(2 -hydroxyethyl)-1-piperazineethanesulfonic acid (HEPES) and 5 mM succinate acid (sodium succinate).

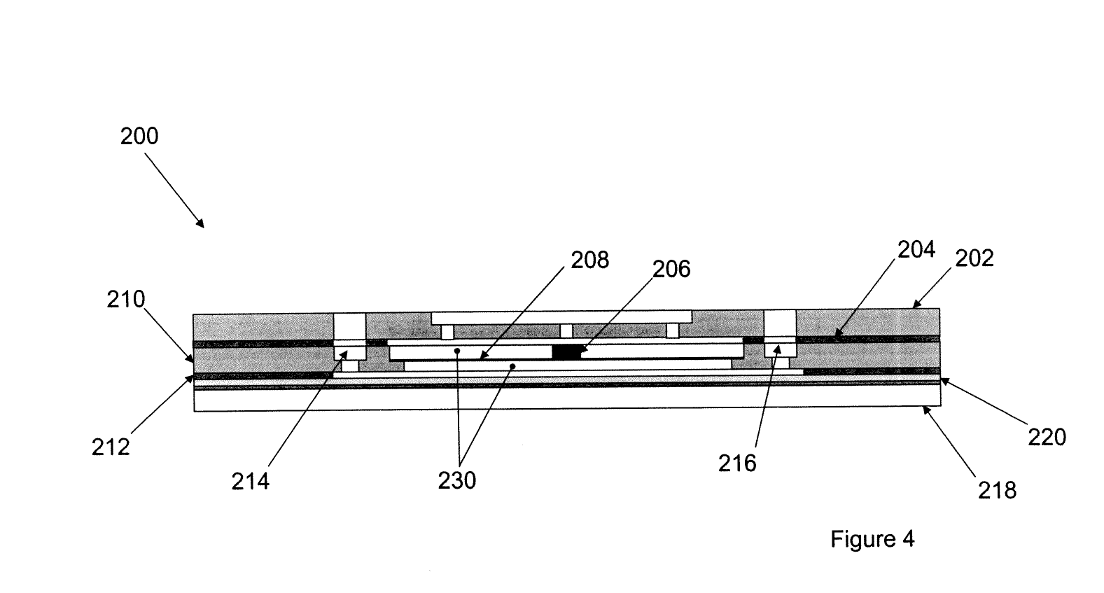

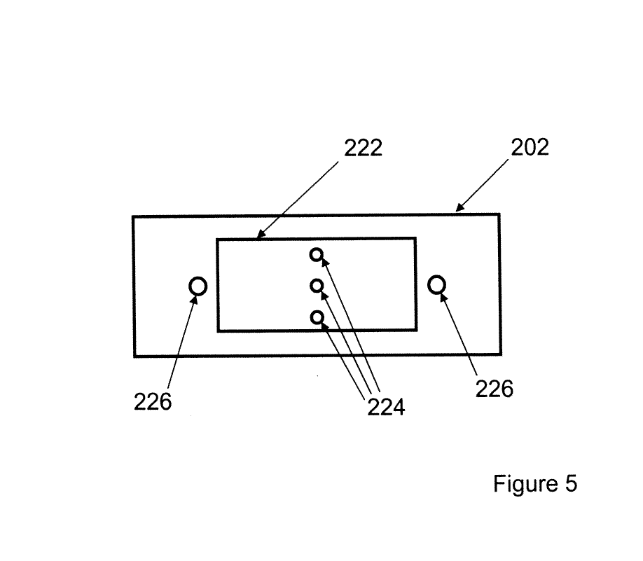

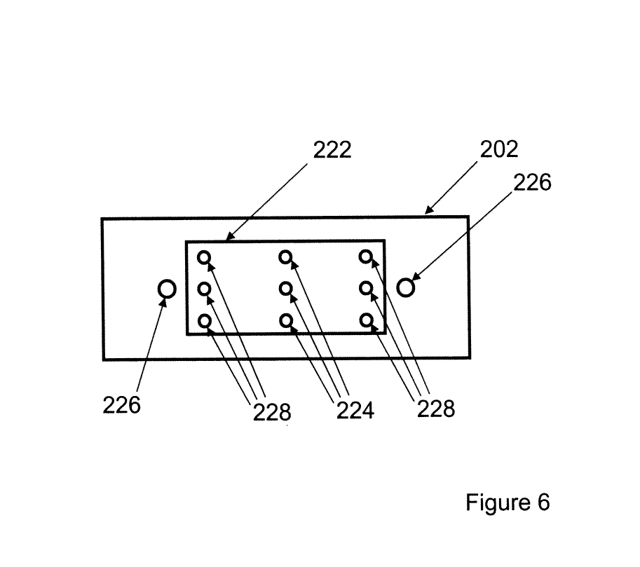

FIGS. 4-6 show a biological battery cell 200, the chemistry of which may be essentially the same as the cell 10 or the cell 100. The construction is different, employing a plate design for the cathode 220 and the metallic anode 206. The cathode 220 is fabricated by depositing a thin layer of gold on a substrate 218. The anode 206 is secured in the plate 202. The metallic anode 206 is coupled via the electrolyte in cavity 230 in the plate 210 to the biological element, for example mitochondrial and/or bacterial cathode 220. The cathode and the anode are separated by the separator 208. This arrangement also allows for the mitochondrial and/or bacterial array itself can act as a separator.

The cathode 220 may be formed on glass slides 218. The anode 206 may be secured in the plastic plate 202 or inserted through holes 224. The plastic plate 202 and 210 have perforations 214, 216, 226, through which the electrolyte may be injected to fill the cavity 230. In the presence of a physical separator, the plate 202 have perforations 228 though which the top of the cavity 230, surrounding the anode, can be filled with the electrode.

Factors influencing the performance of a biological battery may include: the rate of andenosine triphosphate (ATP) per milligram (mg) of protein in the donor biological material and the overall rate of production of ATP, the rate of production of proton reduction (R_{H+}), protein content (m_{P}) of the biological material, protein density (ρₘₚ) of the biological material, theoretical current that can be drawn, and the volume of the biological array. The theoretical capacity of the biological battery using mitochondria as the biological material may be determined according to the following equations:

R¹_{ATP}=17.56 nmol/min−mg protein [1]

ρₘₚ=26 mg/ml [2]

V=1.01 μl

R_{ATP}=R¹_{ATP}×ρ_{mg}×V=17.56×10⁻⁹×26×1.01×10⁻³=4.61×10⁻¹⁰ moles/min

R_{H+}=3×R_{ATP}=1.38×10⁻⁹ moles/min=2.31×10⁻¹¹ moles/sec

I=(# of protons)×(charge on an electron)

I=2.31×10⁻¹¹×6.023×10²³×1.6×10⁻¹⁹=2.22×10⁻⁶ coulomb/sec

theoretical capacity=2.22×10⁻⁶×T/mₚAmp-hr/mg [3]

T: life time of mitochondria, mₚ=0.026 mg (mass of mitochondrial protein)

With reference again to FIGS. 4-6, an assembly process for biological battery cell 200 may begin by preparing the cathode (220) slide 218 by washing, rinsing with deionized water and drying. An anode is prepared from a metal wire and is incorporated in the battery, for example, in the slide 202, through holes 224. The cathode slide 218, intermediate plate 210 and the anode slide 202 are assembled using gaskets 204 and 212. The slide assembly is clamped for leak proof functioning. Leads are taken out by inserting gold wire between the cathode plate 218 and the gasket 212. Metal wire provides the lead from the anode side. Biological material is then injected into the cell onto the gold surface of the slide 218 using the holes 214 and 216. Electrolyte is then injected using the holes 224. With electrolyte present in the battery 200, it is able to deliver DC electric power. It is noted that this construction also functions without a separator because the biological material itself acting as a separator.

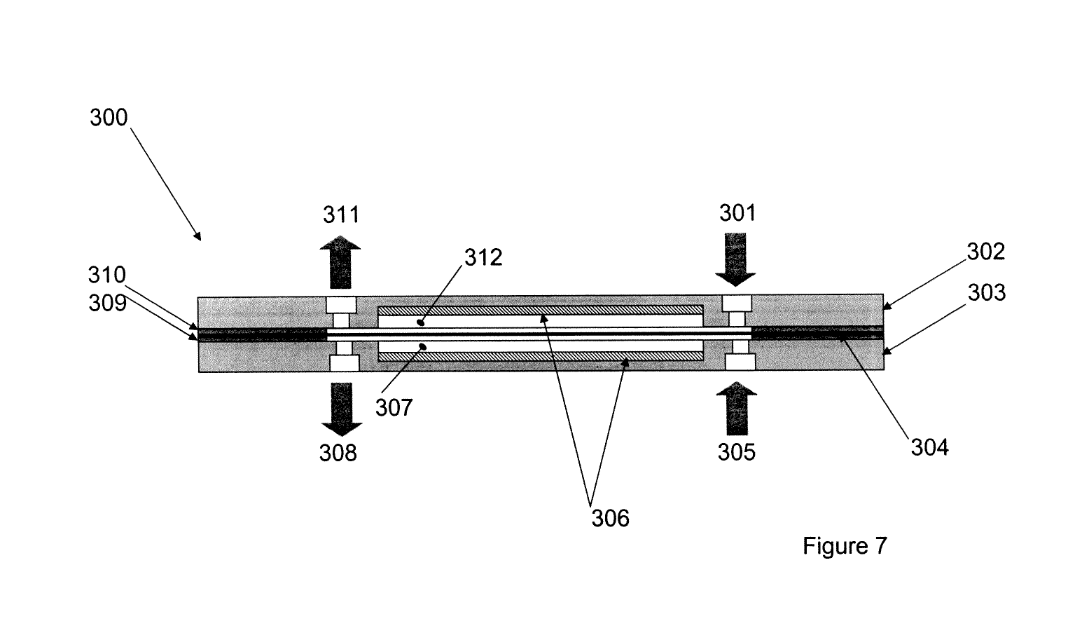

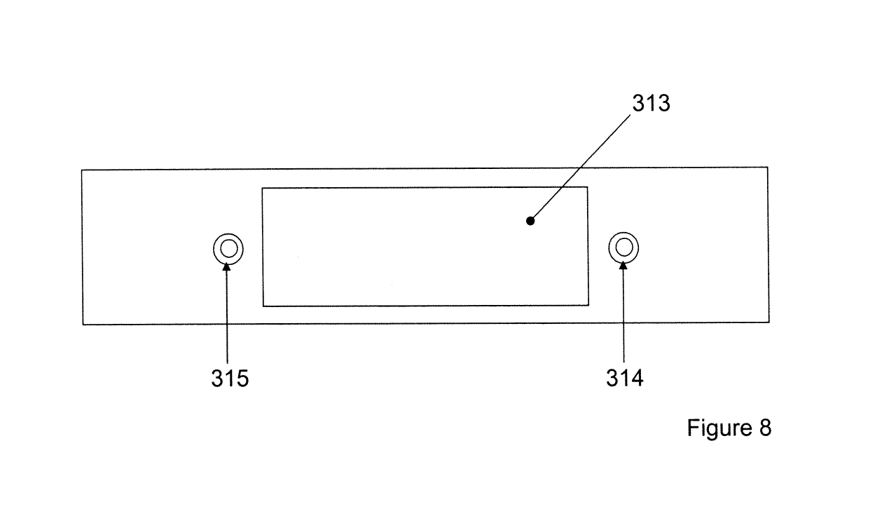

FIGS. 7-8 show a biological battery cell 300, the chemistry of which is different than the cell 100 or the cell 200. The cell employs non-consumable electrodes 306, made from the same material. The cathode 301, 311, and anode 305, 308 are in the form of solutions. The biological element participates as the anode 301, 311 while other electron accepting substance acts as the cathode 305, 308 (FIG. 7). The construction involves use of end plates 302, 303, which have a cavity (FIG. 8, 313) to house the non-consumable electrodes 306 and the materials participating in the battery action (oxidation and reduction reactions) (FIG. 7). The non-consumable electrodes are securely clamped in the cavity. The end plate cavity, holding the anodic material forms the anodic compartment 312 while the end plate cavity holding the cathodic material forms the cathodic compartment 307. The end plates also have machined holes 314, 315 through which, the materials participating in the battery action are injected (FIG. 8). Two end plates with non-consumable electrodes are clamped against each other using two gaskets 309, 310. The cathodic and anodic compartments that will be formed by the cavities in the end plates are separated using a separator 304. The entire assembly is clamped to prevent leakage. Since the cathode and the anode are replenishable in this scheme, we refer to it as the biological fuel cell.

The end plates may be machined from acrylic. The non-consumable electrodes may be obtained using carbon cloth or deposited gold on glass, or similar biologically inert substrates. The gaskets may be machined from a piece of silicon. The separator may be a proton exchange membrane, made of a polymeric material of sufficiently small porosity to prevent permeation of mitochondria.

With reference again to FIGS. 7-8, an assembly process for the biological fuel cell may begin by preparing the non-consumable electrodes 306 and end plates 302, 303 by washing and rinsing them with deionized water. Then the electrodes are securely clamped in the end plate cavities. One Gasket 309, 310 is placed on each end plate. The end plates are pressed against the separator 304, such that the cavities in the end plates face each other from across the membrane (FIG. 7). The end plates, gasket and separator assembly is clamped for leak proof working. The leads from electrodes are taken out using gold wires. The anodic solution is prepared by mixing the biological element, artificial electron acceptor (AEA) and buffer 301, 311. The cathodic solution is prepared by dissolving the electron accepting substance, for example, in deionized water or in buffer 305, 308. The anodic solution is injected in the anodic chamber, and the cathodic solution is injected in the cathodic chamber (FIG. 7). When the non-consumable electrodes are connected through the external path, due to the presence of oxidation and reduction substances in the battery, a direct current is generated.

TABLE III
Exemplary Cell Materials

| | anodic | reducing | | | |
|---|---|---|---|---|---|
| electrodes | solution | substance | separator | gaskets | end plates |
| carbon or | phosphate | ferricyanide | proton | silicon | plastic |
| gold | buffer + | or similar | exchange | | |
| | AEA + | substance | membrane | | |
| | pyruvate | | or similar | | |

AEA: Artificial Electron Acceptor

As described in Table III, this scheme utilizes two types of solutions. The buffer required for mitochondrial anodic solution may be a mixture of 220 mM mannitol, 70 mM sucrose, 0.5 mM ethylene glycol tetraacidic acid (EGTA), 2 mM 4-(2-hydroxyethyl)-1-piperazineethanesulfonic acid (HEPES) and 5 mM pyruvate (sodium pyruvate), or other combination of fuel for mitochondria and artificial electron acceptor. The cathodic solution may be a mixture of 1 mM diPotassium Phosphate (K₂HPO₄) and Potassium Ferricyanide or solution of Potassium Ferricyanide in deionized water, or other combination of reducing substance, and buffer.

While the invention is described in terms of several preferred embodiments of mounting assemblies that may be used in connection with fault protection devices, it will be appreciated that the invention is not limited to such devices. The inventive concepts may be employed in connection with any number of devices and structures. Moreover, while features of various embodiments are shown and described in combination, the features may be implemented individually each such single implementation being within the scope of the invention.

While the present disclosure is susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

We claim:

1. A battery having at least one electrode comprising a biological component including mitochondria.

2. The battery of claim 1, wherein the at least one electrode comprises a cathode.

3. The battery of claim 2, wherein the cathode comprises an annular cylinder, or other extruded shape, the biological component being disposed on an inner surface of the cylinder or other extruded shape.

4. The battery of claim 2, wherein the cathode comprise a rod or a plate.

5. The battery of claim 1 comprising an electrolyte.

5. The battery of claim 1 the electrolyte comprising a weak pH buffer.

6. The battery of claim 1 the electrolyte comprising pH neutral buffer.

7. The battery of claim 1 comprising a pump to circulate the electrolyte.

8. A battery having two non-consumable electrodes, one in the anodic chamber and one in the cathodic chamber.

9. The battery of claim 8, wherein the anodic material comprise a biological component including mitochondria.

12. The battery of claim 8, wherein the cathodic material is in form of solution of a reducing substance.

13. The battery of claim 8 comprising a pump to circulate the solutions.
